(19) United States
(12) Patent Application Publication
(10) Pub. No.: US 2025/0278873 A1
(43) Pub. Date: Sep. 4, 2025

(54) SYSTEMS, DEVICES, AND/OR PROCESSES FOR ARCHITECTURAL SUPPORT IN CONTAINERIZED DEPLOYMENTS

(71) Applicant: Arm Limited, Cambridge (GB)

(72) Inventors: Eric Van Hensbergen, Austin, TX (US); Girish Jagannath Shirasat, Gilbert, AZ (US); Matthew Brian Spencer, Balsham (GB)

(21) Appl. No.: 18/592,285

(22) Filed: Feb. 29, 2024

(51) Int. Cl. G06T 11/60

(52) U.S. Cl. CPC G06T 11/60

(57) ABSTRACT

Briefly, example methods, apparatuses, and/or articles of manufacture are disclosed that may be implemented, in whole or in part, using one or more computing devices to facilitate and/or support one or more operations and/or techniques for containerization, such as implemented, at least in part, via container image support for multiple architectures.

### BACKGROUND

### Field

The present disclosure relates generally to containerization, and more particularly, container image support for multiple architectures.

### Information

Containerization is a widely adopted technology for deployment of software, such as, for example, applications and/or operating systems. A container may be executed in a manner that is isolated from other containers via resource abstraction. For example, containers may be executed with dedicated namespaces, resource limits, storage, mounts, and/or the like. In some cases, containers may include a set of software resources needed by an application to execute on the host kernel, such as libraries, dependencies, source code, and/or the like. Individual containers (container “instances”) may be created by a container runtime based on templates (container “images”) that dictate the creation of a runtime to execute on the host kernel. In particular implementations, images are formatted as an ordered sequence of file system changes.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a flowchart illustrating an example process for container image support for multiple architectures, in accordance with an implementation.

FIG. 2 is a flowchart illustrating an example process for container image support for multiple architectures, in accordance with an implementation.

FIG. 3 is a schematic diagram illustrating an example system of a client-server architecture for container image support for multiple architectures, in accordance with an implementation.

FIG. 4 is a is a schematic diagram illustrating an example system of a client wrapper architecture for container image support for multiple architectures, in accordance with an implementation.

FIG. 5 is a sequence diagram illustrating communications for container image support for multiple architectures, in accordance with an implementation.

FIG. 6 is a schematic diagram illustrating an example system implementation of a network-connected device for container image support for multiple architectures, in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As indicated above, container images may encapsulate resources needed to instantiate containers on a compatible container runtime. For instance, an image may include an operating system distribution, an application, one or more libraries, such as standard libraries. Additionally, in some infrastructures, an image may be built on top of and/or otherwise incorporate other images, which themselves may refer to prior images, and so on. In some cases, at least a portion of these preceding images may be distributed by a third party, for instance, via a public image registry. As a basic example, an image for a customized web server application might include a reference to a standard publicly available image for an operating system (e.g., an Alpine Linux image and/or the like), a reference to a privately developed image for the web server application, a reference to an internet communications library image, a data object (e.g., a binary large object or “blob”) for custom files, and a list of commands to execute during instantiation. Accordingly, even a relatively simple containerized application may rely on a relatively large number of preceding images, which may include various externally provided images.

As indicated above, containers execute in the runtime host's kernel. Accordingly, certain images may be compatible with certain architectures and/or computing systems. For instance, an image for a RISC-V architecture might be incompatible with a container runtime running on an x86 architecture. In some implementations, image providers may create multiple image versions corresponding to different computer architectures. However, some computer architectures (e.g., instruction set architectures) support instruction set extensions, which provide additional features while retaining compatibility with the base architecture. Different systems may implement various variant architectures based on different supported instruction set extensions. For example, an example supercomputing variant might support an extension providing accelerated matrix operations but not support a particular security extension, while an example edge device variant might support the security extension but not support the matrix math extension. Indeed, some architectures may support user-defined and/or otherwise customizable extensions. Accordingly, some architectures might support relatively large and/or indeterminate numbers of variant architectures. It may be challenging and/or impractical for image distributors to develop image versions that are optimized for different variants. Thus, containerized application deployments may under perform and/or lack functionality compared to non-containerized deployments, particularly in relatively modular and/or customizable architectural environments.

Implementations of the described technology may address these and/or other challenges by providing systems, devices, and/or processes for architectural support in containerized software deployments. For example, implementations may provide an intermediary between a container runtime and an image repository to enable the runtime to interact with an image registry while requesting image versions for variant architectures (“variant images”) that don't exist in the repository. In some examples, requests for variant images may be tracked, built as requested (e.g., in a just-in-time manner), and/or served from an intermediary cache.

For ease of explanation, examples of inter-process communications, such as requests and responses, may be described in terms of a web application programming interface (API) accessed via HTTP calls (such as, e.g. POST, GET, PUT, etc.) to API-specific uniform resource locations (urls). Other implementations may employ various other inter process communication techniques without departing from the scope of the described technology. For example, messages and/or content may be exchanged via other REST (representational state transfer) APIs, non-REST APIs (such as, eg. Simple Object Access Protocol (SOAP), Remote Procedure Call (RPC)), and/or the like.

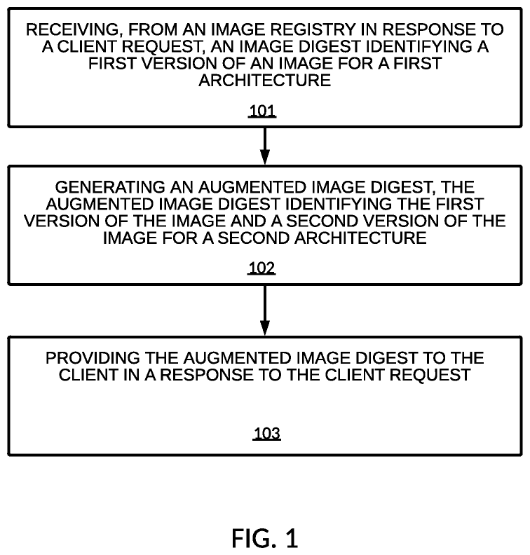

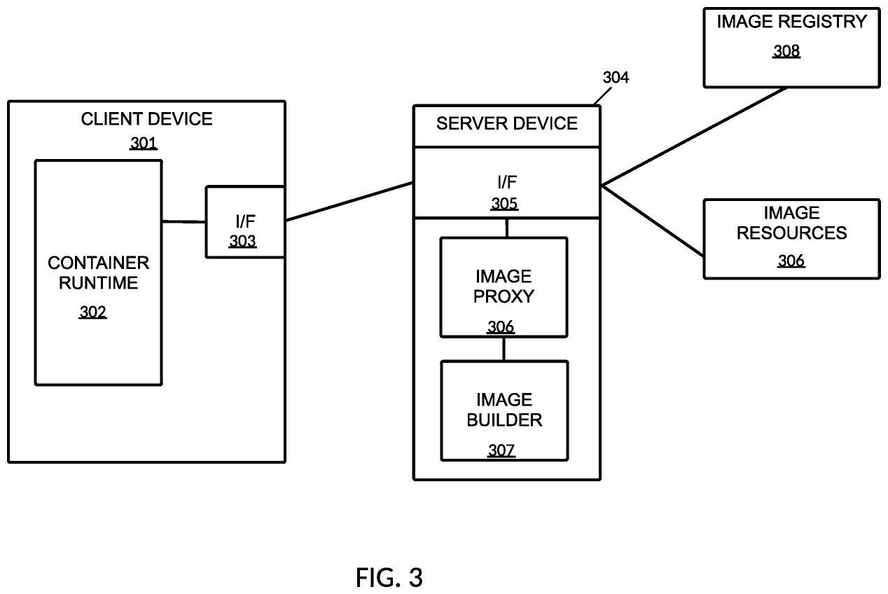

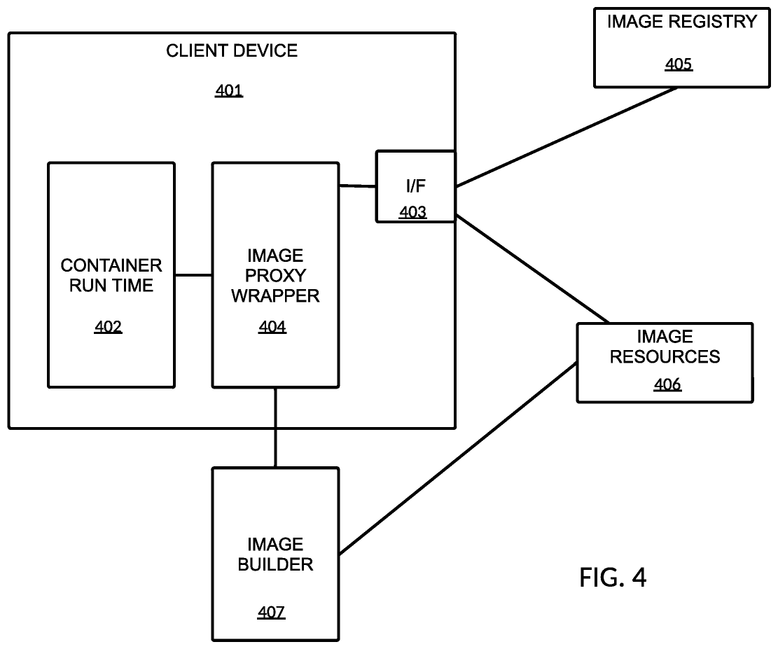

FIG. 1 is a flowchart illustrating an example implementation of a method for architectural support in containerized software deployments. Implementations of the illustrated example may be performed by various components in a containerized software environment. For example, implementations may be performed by a proxy server as described with respect to FIG. 3. As another example, implementations of the illustrated example may be performed by a client-side component, such as an intermediate wrapper, driver, application programming interface (API), and/or the like, as described with respect to FIG. 4. In further examples, implementations may be performed by other suitable components within a container execution environment, including any other example device and/or system as described herein.

In some implementations, the method may include operation 101, which may include receiving an image digest in response to a client request, where the image digest identifies a first version of an image for a containerized application executable in a first architecture. In implementations, the client request may be any message related to retrieval of an image from a registry. For example, the client request may be a request to retrieve an image (e.g., an image pull command) and/or a request to identify available image versions (e.g., a image discovery query).

In some implementations, the client request may identify the first architecture (e.g., a container pull request for an image of Application X for ISAA). In further cases, the client request may identify a second architecture, such as a variant of the first architecture (e.g., a container pull request for an image of Application X for ISAA.M). For instance, the image registry may be programmed to respond with an alternative version (such as, e.g., closest available variant, a base architectural version, and/or the like) when it lacks a requested version. As another example, the client request may identify the first architecture in a first information element (e.g., in a dedicated architecture field in a formatted request and/or as an input to the request) and the second architecture in a second information element (e.g., a dedicated variant field in a request body and/or request input). In some implementations, the client request might not identify any particular architecture. For instance, the image digest may be provided in response to a request for all versions of an image and/or all versions meeting a provided query.

In various implementations, the image digest may be any file, message, document, binary object, and/or the like that identifies and/or describes resources for retrieving a container image from a registry. For instance, the image digest may be a data object, such as, for example, a markup language object, contained in the body of a message and/or as a data file, such as, for example, an HTTP message. In various implementations, an image digest may include information about a specific version of an image and/or may include information about multiple versions of an image. For example, the image digest may be an image manifest that describes content for a specific image version, such as configurations, data object identifiers and/or locations, embedded content, and/or the like. For instance, the image digest may be formatted as an image manifest as defined by a container-related standard promulgated by the Open Containers Initiative (OCI). As another example, the image digest may be an image index that includes a list identifying one or more versions of an image. For example, the image digest may include a list of image manifests for specific image versions. For instance, the image digest may be formatted as an image index as defined by an OCI standard. In further examples, the image digest may include information identifying resources for one or more specific image versions and information identifying a list of image manifests for other versions of the image.

The example method may further include operation 102, which may include generating an augmented image digest. In some implementations, the augmented image digest may identify the first version (included in the response received in operation 101) as well as a second version of the image for a second architecture. For example, in an containerization environment with both image manifests and image indexes, the augmented image digest may be formatted as an image index that identifies an image manifest for each version. In some implementations, the augmented image digest and the image digest received in operation 101 may have the same format. For instance, if the received image digest were an image index identifying one or more image manifests, the augmented image digest may be generated appending an identifier for the second version of the image to the received list. In some implementations, the augmented image digest may have a different format than the received image digest. For instance, if the received image digest is an image manifest, the augmented image digest may be an image index that identifies the received, first image manifest as well as a second manifest for the second version. In some examples, the second manifest included in the generated image index might not exist. For example, the identification of the second version of the image may be made via a placeholder and/or dummy entry. For example, the augmented image digest may include a descriptor for a second manifest including a URL for its retrieval. In this example, the second manifest may be generated and stored at the URL in response to a client's subsequent request for that manifest.

In some implementations, the second architecture may be determined according to client computing architecture information, such as, for example, the client's computer architecture and/or what architectural extensions it implements. In these implementations, the client-specific information may be provided in various manners. For example, the information may be provided by the client as a configuration parameter and/or retrieved via system calls and/or the like, such as, for example to a client wrapper program performing the operations. As another example, the information may be provided via messaging external to the containerization protocol, such as, for example, to a proxy server performing the operations. As a further example, a client may communicate the desired second architecture via protocol-defined messaging. For instance, the second architecture may be identified in a variant identifying field, a features-identifying field, a vendor-defined optional field, and/or the like. As an example, the second architecture may be communicated as information included in the client's image request preceding operation 101. As a first particular example, the client image request may include a data object such as {“architecture”: “ARCH”, “variant”: “MEC”}, where the “architecture” key-value pair identifies the first architecture (“ARCH” in this example) and the “variant” key-value pair identifies the second architecture (in this example, “M”: matrix math; “E”: encryption operations; “C”: coding (e.g., hardware encoding/decoding)). As a second particular object, the client image request may include a data object such as {“architecture”: “ARCH”, “variant”: “v8”, “features”: “MEC”}, where “architecture” and “variant” identify the first architecture (ARCH, version 8) and “features” identifies the second architecture (ARCH, version 8, MEC extensions). In some implementations, the second architecture may be determined according to other information, such as, for example, supported variant architectures. For example, the second architecture may be determined according to which requested extensions are supported. For instance, in the example {“architecture”: “ARCH”, “variant”: “MEC”}, the augmented image digest might include an identifier for the second image including {“architecture”: “ARCH”, “variant”: “M”} to indicate that the matrix math extensions are supported, but the encryption and coding extensions are not.

The example method may further include operation 103, which may include providing the augmented image digest to the client in a response to the client request. In some implementations, operation 103 may be performed by the target of the client request. For instance, operation 103 may be performed by a proxy server serving as an image registry. In some implementations, operation 103 may be performed by a component other than the target of the request. For instance, a client wrapper program may perform operation 103 by translating an incoming response prior to providing it to the client. Examples of these and further implementations are described below with respect to FIGS. 1-6.

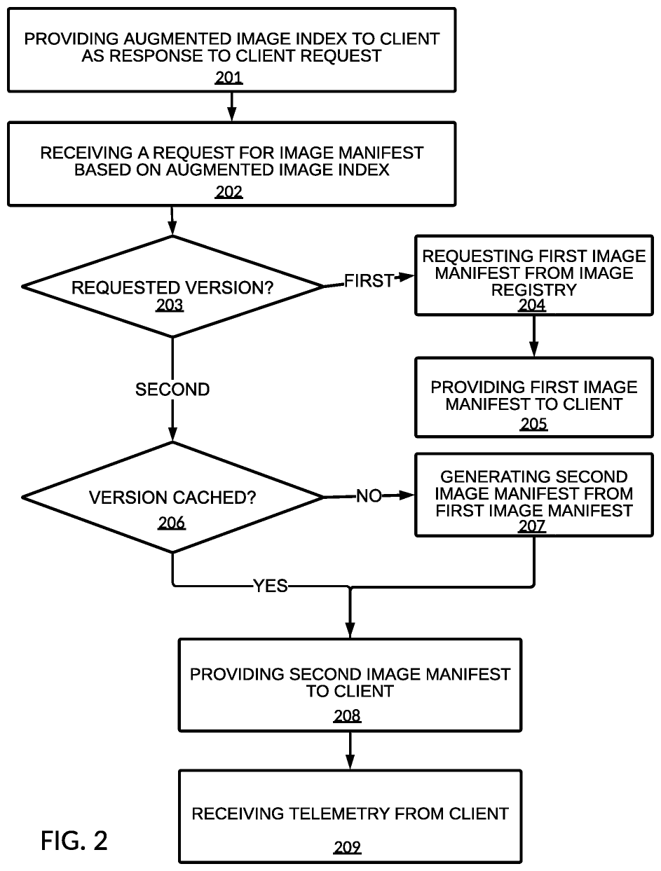

Turning now to FIG. 2, FIG. 2 is a flowchart illustrating an example implementation of a method for architectural support in containerized software deployments. In this example, a version of an image to support a variant architecture is generated and/or served from a cache in response to a client request. For example, the illustrated method may be performed as an aspect and/or continuation of the operation illustrated in FIG. 1 and may be performed by an example device as described with respect to FIGS. 3, 4, and 6. In particular, the example method is described with respect to a containerization environment that includes image indexes, which provide a list of available images, and image manifests, which describe a specific version of an image.

The example method may include operation 201, which may include providing an augmented image index to a client. For example, operation 201 may be performed as described with respect to FIG. 1. For instance, as described above, operation 201 may be performed to provide the augmented image index in place of an image digest provided by an image registry. In particular, as described above, the augmented image index may list a first image manifest received from an image registry and a second image manifest that was not received from the image registry. For instance, the first image manifest may be for a first architecture, while the second image manifest may be for a second architecture, such as, for example, an extension to the first architecture.

The example method may further include operation 202, which may include receiving a request for an image manifest. In some implementations, the request may be based on the augmented image index provided in operation 201 by identifying one of the image manifests listed in the augmented image index. The request may reflect a selection by the client for a particular image. For instance, the request for the image manifest may be generated by the client as an aspect of an image retrieval process, such as a containerization protocol-defined process flow. The example method may further include operation 203, which may include determining which image manifest was requested in operation 202 and proceeding accordingly.

The example method may further include example operations 204 and 205, which may be performed in response to a request from the client for the first image manifest (e.g., the image manifest received from and/or available at the image registry). Operation 204 may include requesting the first image manifest from the image registry. For instance, operation 204 may be performed in response to the image registry sending an image index (e.g., as described with respect to operation 101 of FIG. 1). In some implementations, operation 204 may be optionally performed. For instance, if the image registry had already provided the first image manifest in response to the initial request, then operation 204 may be skipped or may be performed by verifying that the previously received image manifest remains valid. Operation 205 may include providing the first image manifest to the client. In some implementations, the client may proceed with retrieving the first version of the image according to the contents of the first image manifest.

Returning to operation 203, in response to the client requesting the second image manifest, the example method may proceed to operation 206. In some implementations, operation 206 may be performed to determine if a cached copy of the second version of the image is available. For example, operation 206 may include determining if a previously built second version of the image remains valid. For example, operation 206 may include verifying that the image upon which the cached version was built remains valid. In these implementations, operation 206 may include communicating with the image registry to check the validity of the first image manifest. For instance, operation 206 may include comparing a checksum, hash, and/or the like between an up-to-date copy of the first image manifest and the earlier copy used to build the cached version. For example, operation 206 may include performing a containerization protocol-defined procedure for verifying image manifests.

The example method may further include operation 207, which may include generating the second image manifest. In some implementations, the second image manifest may be generated based, at least in part, on the first image manifest and an architectural feature of the second architecture. For example, an architectural feature may include an instruction set architectural (ISA) or like-leveled feature, such as, for example, ability to execute certain instructions and/or perform certain operations (e.g., matrix, vector, or the like), security and/or other extensions, and the like. As another example, an architectural feature may include a microarchitectural and/or other like feature, such as, for example, features that may vary between two versions of a processor that execute the same ISA, cache sizes/configurations (e.g., presence or absence of certain cache levels, such as an L3 cache, shareability of certain caches, cache coherency protocols, sizes of certain caches, such as L1 data cache, and/or the like), cache-line and/or page size, instruction execution speeds, inter processor communication bandwidth/speed, and/or the like. As another example, an architectural feature may include a computer-architecture and/or other like leveled feature, such as, for example, memory bandwidth, memory sizes, storage speeds, presence and/or absence of various accelerators, in-memory and/or in-storage computational abilities, and/or the like.

In some implementations, operation 207 may include using the first image manifest to instantiate a container instance of the first version of the image (a “base container”). In this example, operation 207 may include modifying the base container based on an architectural feature of the second architecture. For instance, operation 207 may include executing a patch, script, and/or the like to modify the base container. As an example, operation 207 may include replacing and/or otherwise modifying container code (e.g., a software library) to one that includes code that utilizes an architectural extension and/or other ISA-related feature. As a further example, operation 207 may include replacing and/or other modifying container code (e.g., a software library) to one that takes advantage of a microarchitectural feature. For instance, as a non-limiting example, operation 207 may include adding/replacing a message-passing tool library to one that takes advantage of an expanded cache size. As another example, operation 27 may include replacing and/or modifying container code to utilize a computer-architectural features. For instance, as a non-limiting example, operation 207 may include adding/replacing a software library to one that includes and/or otherwise utilizes in-storage and/or in-memory processing commands. As a further example, operation 207 may include changing variable configuration parameters to take advantage of the second architecture. For instance, in a containerized computer vision application, operation 207 might comprise updating a configuration setting (e.g., updating a setting to use a hardware extension). As another example, operation 207 may include upgrading, installing, replacing, and/or otherwise changing an executable within the base container.

In some implementations, operation 207 may include building the second version of the image by generating a container image based on the modified base container. Here, the second image manifest may be generated as an aspect of the container image building process. For instance, operation 207 may include utilizing container building functionality present in the applicable containerization protocol. In some implementations, the second image manifest may reference and/or incorporate aspects of the first image manifest. For instance, in some containerization protocols, containers are formatted as a sequence of file layer descriptors, where each descriptor identifies a layer that represents file system changes with respect to its preceding layer. In some examples, operation 207 may include generating the second image manifest to reference the layer sequence of the first image manifest (e.g., by including the file system layer descriptors present in the first image manifest). In these examples, operation 207 may comprise appending an additional file system layer descriptor to the sequence. In further examples, operation 207 may include replacing a layer from the first image manifest with a new layer. In such examples, operation 207 may further comprise rebuilding the layers following the replaced layer in the manifest sequence. For instance, operation 207 may comprise generating an second image manifest that references the first N-1 layers of the first image (where N represents the sequence number of the new layer).

The method may further include operations 208 and 209. Operation 208 includes providing the cached and/or newly built second image manifest to the client. For example, operation 208 may be performed according to protocol specifications of the containerization environment. Operation 209 includes receiving telemetry regarding the second version of the image from the client in response to instantiation of the second version of the image. For example, operation 209 may include receiving an indication of whether or not the client successfully instantiated the second version of the image. As another example, operation 209 may include receiving telemetry data regarding a running instance of the second version, such as, for example, resource usage statistics, performance characteristics, logs, traces, and/or the like. In some cases, such telemetry may include telemetry regarding execution of processes within the instantiated image version. For instance, the telemetry may include information, (e.g., traces, logs, metrics, etc.) specific to the usage of the features of the second architecture, such as calls to any modified libraries, power usage of hardware extensions, and/or the like. In further cases, the telemetry may include telemetry regarding the container itself, such as container health messages, container host/runtime resource usage, etc. Such telemetry may be collected in any manner used in containerized environments, such as, for example, via monitoring programs installed in the second image and/or telemetry information surfaced by the applicable containerization runtime.

Turning now to FIGS. 3 and 4, the figures illustrate example systems and/or devices implementing architectural support in containerized software deployments. In particular, in particular, the figures illustrate example implementations to perform at least a portion of the example operations described with respect to FIGS. 1, 2, and 5. FIG. 3 illustrates an example including a server device implementation and FIG. 4 illustrates an example including a client runtime wrapper implementation. These examples are neither exhaustive nor exclusionary. For instance, further implementations may include both server executed operations and wrapper executed operations. As another example, further implementations may have include a container runtime that performs at least a portion of the example operations. Additionally, the illustrated devices may be implemented as physical “bare metal” machines, virtual machines, software containers, partitions, and/or the like. For instance, devices illustrated as separated may be implemented on the physical machine. Likewise, components illustrated as combined may be implemented on separate computing systems. For instance, an image builder component may be executed by a separate device in the container runtime environment.

Turning now to FIG. 3, the example implementation includes a client device 301 coupled to a server device 304 serving as an image registry proxy. In some implementations, client device 301 may include a container runtime 302. For instance, container runtime 302 may be a software component that executes functionality provided by its host operating system to provide name spaces and execution environments for containers. In some implementations, container runtime 302 may perform various life cycle related operations, such as instantiation, execution, and deletion. In some implementations, some or all of these life cycle functions may be standardized by a containerization protocol. For instance, container runtime 302 may have instantiation functions to retrieve a container digest (including, for example, image indexes and manifests), to retrieve data referenced in a container digest (such as, e.g., file system blobs), and to instantiate a container based on the retrieved data and a configuration identified by and/or contained in the container digest. Continuing the example, the container runtime may have execution instructions to control the execution of the container on the host kernel, such as, for example, functions to start running a container, inspect and/or issues commands to a container, shut down and/or kill a container, and/or the like. Continuing the example, the container runtime may have container removal functions, such as deleting a container by undoing the instantiation steps, executing post-operation scripts/hooks, and/or the like. In further implementations, the container runtime component 302 may include additional functions, such as building a container image. In some implementations, container runtime 302 may interact with an image registry to retrieve container images. In the illustrated example, client device 301 connects to a server device 304 via an interface 303, where server device 304 acts as an image registry.

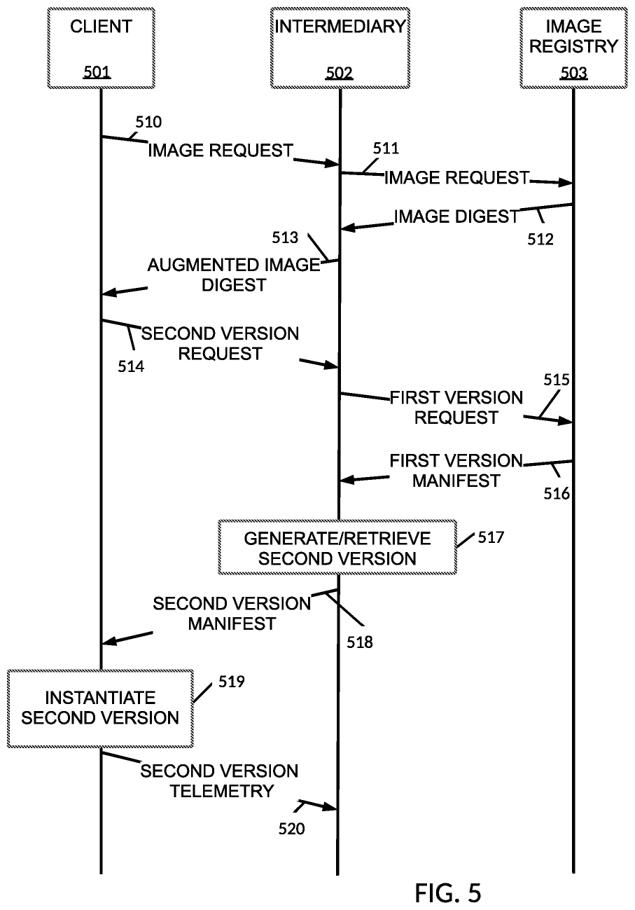

As illustrated, server device 304 may be coupled to client device 301 as well as an image registry 306 via an interface 305. In this example, the server device 304 include an image proxy component 306. Here, image proxy component 306 may be executed to respond to client device 301 as an image registry. Additionally, image proxy 306 may connect to another image registry 308 as a client. For example, server device 304 may perform operations such as those described with respect to FIGS. 1, 2, via messaging as illustrated in FIG. 5.

In the illustrated example, server device 304 may include an image builder component 307. The image builder component 307 may comprise software executable by the server device 304 to generate an augmented image digest as well as a second version of an image along with its associated image manifest. For instance, builder component 307 may be executed to generate a second image manifest based on a first image manifest and a feature of a second architecture, as described, for example, with respect to operation 207 of FIG. 2. In some implementations, server device 304 may communicate with one or more image resource storage locations 306. For example, the image resource locations 306 may include local storage devices, networked storage devices, abstracted/virtual storage devices, caches, and/or the like. The image resource storage 306 may include resources to build and/or execute the second version of the image. For instance, image resource storage 306 may comprise operating system code, libraries, scripts, and/or the like that implement the extended features provided by the second architecture.

As discussed above, in some implementations, rather than build a second image, the server may generate a request for the second image to be built, which may be provided to image registry 308 or other designated entity. In these implementations, server device 304 may lack a builder component 307 and image proxy component 306 may be executed to generate augmented image digest without creating the second image. For instance, image proxy component may be executed to generate the augmented image digest using placeholders, dummy values, and/or the like.

Turning now to FIG. 4, the example implementation includes a client device 401 coupled to an image registry with a wrapper component performing image proxy operations. In this example, a client device 401 may execute a container runtime component 402 to communicate with an image registry 405. Except as otherwise indicated, container runtime 402, image registry 405, image resource storage 406, and image builder component 407 may be implemented as described with respect to container runtime 302, image registry 304, image resource storage 306, and image builder component 307 of FIG. 3, respectively. In various implementations, client device 401 may execute an image proxy wrapper component 404 to implement some or all of the operations described with respect to FIGS. 1, 2, 5. In some implementations, the image proxy 404 may intercept communications over interface 403 between container runtime 402 and image registry 405. For instance, image proxy wrapper component 404 may comprise device driver code to appear to the container run time as a driver for interface 403.

In some implementations, image proxy wrapper 404 is coupled to an image builder component 407. For example, image builder component 407 may be a component within the container runtime 402 and/or may be a separate component within the containerization environment. As discussed above, an example operation may include building a second version of an image based, at least in part, on a first image provided by image registry 405.

As discussed herein, the wrapper component 404 may implement the example operations by modifying communications with the image registry 405. For instance, to implement the method of FIG. 1, wrapper component 404 may replace image registry 405's response (e.g., the first image digest) with the augmented image digest. As another example, wrapper component 404 may implemented operations 202 and 207 of FIG. 2 by modifying client runtime 402's request for the second image manifest into a request for the first image manifest. Continuing this example, wrapper 404 may invoke the build component 407 to build the second version of the image and it's manifest. Wrapper 404 may then provide the second version of the manifest in response to client runtime 402's request.

Turning now to FIG. 5, the figure is a sequence diagram illustrating an example implementation of architectural support in containerized software deployments. FIG. 5 illustrates a sequence of interactions between a client 501, an intermediary 502, and an image registry 503. In some implementations, these entities may be as described with respect to FIGS. 3, 4, and 9 and may operate as described with respect to FIGS. 1 and 2. For example, intermediary 502 may comprise a server, such as server device 304 of FIG. 3. As another example, intermediary 502 may comprise a component executed at the client, such as wrapper component 404 of FIG. 4. Additionally, intermediary 502 may perform various roles in the containerization environment according to different implementations. For instance, as described above, in some implementations, intermediary 502 may interact with the client 501 as an image registry, while in further implementations, intermediary 502 may be transparent to the client 501.

Turning now to FIG. 5, the example sequence may include client 501 issuing an image request 510. Image request 510 may comprise various container retrieval-related commands, such as, for example, retrieval commands defined by a containerization protocol. For instance, image request 510 may be a request to provide a list of available images for a particular containerized application, a request to provide a particular image for the containerized application, a request to provide a list of images compatible with a particular architecture, and/or the like.

The example sequence may further include intermediary 502 providing an image request message 511 to an image registry 503. In some implementations, the image request message 511 may be a forwarded copy of image request message 510. For instance, this may occur in an implementation where the intermediary 502 is transparent to the client 501 and the client 501 addresses its image request message 510 to the image registry 503. In further implementations, image request message 511 may be a second request message generated by intermediary 502. For instance, this may occur in an implementation where intermediary 502 connects to client 501 as an image registry. In these implementations, the image request message 510 may be addressed to the intermediary 502 and image request message 511 may be addressed to image registry 503.

The example sequence may further include image registry 503 providing an image digest message 512 to intermediary 502. For instance, image digest 512 may be provided to intermediary 502 as described with respect to operation 101 of FIG. 1. Again, in some implementations, the image digest message 512 may be addressed to intermediary 502, while in further implementations, the image digest message 512 may be addressed to client 501. As described above, the image digest 512 may comprise various message types that identify a first version of the image. For instance, image digest 512 may include an image index identifying a first version image manifest and/or may be the first version image manifest itself.

The example sequence may further include intermediary 502 providing an augmented image digest 513 to client 501 as a response to image request 510. For instance, this may be performed as described with respect to operations 102 and 103 of FIG. 1. In some implementations, augmented image digest 512 may be formatted as the same type of message as image digest 512, while in further implementations, augmented image digest 513 may be formatted as a different type of image digest. For instance, in some implementations, the augmented image digest 512 may be formatted as an image index identifying a first image manifest provided by image registry 503 and a second image manifest generated by intermediary 502.

The example sequence may further include client 501 providing a request for the second version of the image 514 to intermediary 502. As described above, in some implementations, the request 514 may be addressed to the intermediary as an image registry, while in other implementations, the request 514 may be addressed to the image registry 503 and intercepted by intermediary 502. For example, the request for the second version of the image 514 may occur as described with respect to operations 203, 206, and 207.

The example sequence may further include intermediary 502 providing a request for the first version of the image 515 to the image registry 503 and the image registry responding 516 with the requested manifest. The sequence further includes intermediary 502 generating and/or retrieving the second version of the image 517. For example, as described with respect to operation 207 of FIG. 2, intermediary 602 may request the first version 515 in order to build a second version of the image based on the first during operation 517 (and accompanying second version image manifest). As another example, intermediary 502 may issue the request 515 for the first version to verify the validity of a cached copy of the second version (e.g., to verify if the first version of the image used to build the second version of the image has not become stale) during retrieval of the second version image manifest.

The example sequence may further include intermediary 502 providing the second version manifest 518 to client 501. For example, this message may be generated and sent as described with respect to operation 208 of FIG. 2. For instance, the second image manifest may be newly generated based on a newly built second version image. In this case, the second image manifest may differ from but correspond to a placeholder, dummy value, etc. included in the augmented image digest. As another example, the second image manifest may be previously generated, for example, as a cached version from a previous performance of these operations. In this case, the second image manifest may be same manifest identified in the augmented image index.

The example sequence further includes the client 501 instantiating the second version of the image 519. Additionally, in some implementations, the example sequence may include client 501 providing telemetry regarding the instantiation 520 to intermediary 502. For example, client 501 may instantiate the second version of the image and provide telemetry as described with respect to operations 208-209 of FIG. 2. For instance, as described above, the telemetry 520 may include an indication of success or failure of the instantiation, telemetry data with respect to processes within the container instance, telemetry data with respect to the container instance itself, and/or the like.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term “network device” refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) and/or JavaScript Object Notation (“JSON”) may also be utilized to specify digital content and/or to specify a format thereof, such as in the form of an electronic file and/or an electronic document, such as a Web page, Web site, etc., in an embodiment. Of course, HTML XML and/or JSON are merely examples of “markup” languages, provided as non-limiting illustrations. Furthermore, HTML, XML and/or JSON are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including JSON, HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations. As was indicated, in the context of the present disclosure, the terms “entry,” “electronic entry,” “document,” “electronic document,” “content”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise regular files, directories, sockets, symbolic links, lock devices, character devices, FIFOs, and/or the like. For instance, a file may include a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, Apple Talk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, Apple Talk and/or the like. Versions of the Internet Protocol (IP) may include IPv4, IPv6, and/or other later tov be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

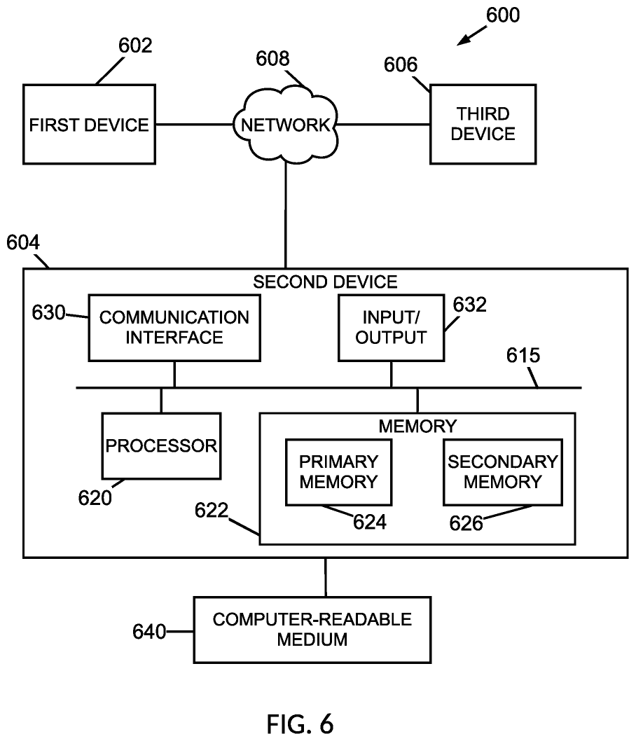

In one example embodiment, as shown in FIG. 6, a system embodiment may comprise a local network (e.g., a second device 604 and a computer-readable medium 640) and/or another type of network, such as a computing and/or communications network. For purposes of illustration, therefore, FIG. 6 shows an embodiment 600 of a system that may be employed to implement either type or both types of networks. Network 608 may comprise one or more network connections, links, processes, services, applications, and/or resources to facilitate and/or support communications, such as an exchange of communication signals, for example, between a computing device, such as 602, and another computing device, such as 606, which may, for example, comprise one or more client computing devices and/or one or more server computing device. By way of example, but not limitation, network 608 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 6 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present disclosure at least, this is understood to refer to sufficient structure within the meaning of 35 § USC 112 (f) so that it is specifically intended that 35 § USC 112 (f) not be implicated by use of the term “computing device” and/or similar terms; however, if it is determined, for some reason not immediately apparent, that the foregoing understanding cannot stand and that 35 § USC 112 (f) therefore, necessarily is implicated by the use of the term “computing device” and/or similar terms, then, it is intended, pursuant to that statutory section, that corresponding structure, material and/or acts for performing one or more functions be understood and be interpreted to be described in the present disclosure.

Referring now to FIG. 6, in an embodiment, first and third devices 602 and 606 may be capable of rendering a graphical user interface (GUI) for a network device and/or a computing device, for example, so that a user-operator may engage in system use. Device 604 may potentially serve a similar function in this illustration. Likewise, in FIG. 6, computing device 602 ('first device' in figure) may interface with computing device 604 ('second device' in figure), which may, for example, also comprise features of a client computing device and/or a server computing device, in an embodiment. Processor (e.g., processing device) 620 and memory 622, which may comprise primary memory 624 and secondary memory 626, may communicate by way of a communication bus 615, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 604, as depicted in FIG. 6, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as IOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of e-mail, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 6, computing device 602 may provide one or more sources of executable computer instructions in the form physical states and/or signals (e.g., stored in memory states), for example. Computing device 602 may communicate with computing device 604 by way of a network connection, such as via network 608, for example. As previously mentioned, a connection, while physical, may not necessarily be tangible. Although computing device 604 of FIG. 6 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may be utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a device-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 6, processor 620 may comprise one or more circuits, such as digital circuits, to perform at least a portion of a computing procedure and/or process. By way of example, but not limitation, processor 620 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method, comprising:
receiving, from an image registry in response to a client request, an image digest identifying a first version of an image for a first architecture;
generating an augmented image digest, the augmented image digest identifying the first version of the image and a second version of the image for a second architecture; and
providing the augmented image digest to the client in a response to the client request.

2. The method of claim 1, further comprising:
receiving, from the client in response to the augmented image digest, a request for the second version of the image;
in response to the request for the second version of the image, providing a request for the first version of the image to the image registry; and
receiving, from the image registry, a first image manifest for the first version of the image.

3. The method of claim 2, further comprising:
generating a second image manifest for the second version of the image based, at least in part, on the first image manifest and an architectural feature of the second architecture; and
providing the second image manifest to the client.

4. The method of claim 3, wherein:
the first image manifest identifies a sequence of file system layer descriptors; and
generating the second image manifest comprises appending an additional file system layer descriptor to the sequence or modifying an entry of the sequence to support the architectural feature.

5. The method of claim 2, further comprising, responsive to the request for the second version of the image:
providing the first image manifest to the client; and
providing a request for a second image manifest for the second version of the image to an address associated with the image registry.

6. The method of claim 2, further comprising, responsive to the request for the second version of the image:
instantiating the first version of the image based on the first image manifest;
modifying the instance of the first version of the image based, at least in part, on the second architecture; and
generating the second version of the image and the second image manifest based, at least in part, on the modified instance of the first version of the image.

7. The method of claim 6, further comprising:
receiving telemetry data regarding the second version of the image from the client in response to instantiation of the second version of the image.

8. The method of claim 6, further comprising:
caching the second version of the image; and
responsive to a subsequent request for the second version of the image, providing the cached version of the image.

9. A device, comprising:
at least one processor to:
receive, from an image registry in response to a client request, an image digest identifying a first version of an image for a first architecture;
generate an augmented image digest, the augmented image digest identifying the first version of the image and a second version of the image for a second architecture; and
provide the augmented image digest to the client in a response to the client request.

10. The device of claim 9, wherein the one or more processors are further to:
receive, from the client in response to the augmented image digest, a request for the second version of the image;
in response to the request for the second version of the image, provide a request for the first version of the image to the image registry; and
receive, from the image registry, a first image manifest for the first version of the image.

11. The device of claim 10, wherein the one or more processors are further to:
generate a second image manifest for the second version of the image based, at least in part, on the first image manifest and an architectural feature of the second architecture; and
provide the second image manifest to the client.

12. The device of claim 11, wherein:
the first image manifest identifies a sequence of file system layer descriptors; and
the one or more processors are further to append an additional file system layer descriptor to the sequence or modify an entry of the sequence to support the architectural feature to generate the second image manifest.

13. The device of claim 10, wherein the one or more processors are further to, responsive to the request for the second version of the image:
provide the first image manifest to the client; and
provide a request for a second image manifest for the second version of the image to an address associated with the image registry.

14. The device of claim 10, wherein the one or more processors are further to, responsive to the request for the second version of the image:
instantiate the first version of the image based on the first image manifest;
modify the instance of the first version of the image based, at least in part, on the second architecture; and
generate the second version of the image and the second image manifest based, at least in part, on the modified instance of the first version of the image.

15. The device of claim 14, wherein the one or more processors are further to receive telemetry data regarding the second version of the image from the client in response to instantiation of the second version of the image.

16. An article comprising:
a non-transitory storage medium comprising computer-readable instructions stored thereon and executable by a computing device to:
receive, from an image registry in response to a client request, an image digest identifying a first version of an image for a first architecture;
generate an augmented image digest, the augmented image digest identifying the first version of the image and a second version of the image for a second architecture; and
provide the augmented image digest to the client in a response to the client request.

17. The article of claim 16, wherein the instructions are further executable by the computing device to:
receive, from the client in response to the augmented image digest, a request for the second version of the image;
in response to the request for the second version of the image, provide a request for the first version of the image to the image registry; and
receive, from the image registry, a first image manifest for the first version of the image.

18. The article of claim 17, wherein the instructions are further executable by the computing device to:
generate a second image manifest for the second version of the image based, at least in part, on the first image manifest and an architectural feature of the second architecture; and
provide the second image manifest to the client.

19. The article of claim 18, wherein:
the first image manifest identifies a sequence of file system layer descriptors; and
the instructions are further executable by the computing device to append an additional file system layer descriptor to the sequence or modify an entry of the sequence to support the architectural feature to generate the second image manifest.

20. The article of claim 17, wherein the instructions are further executable by the computing device to, responsive to the request for the second version of the image:
provide the first image manifest to the client; and
provide a request for a second image manifest for the second version of the image to an address associated with the image registry.
